(19) United States
(12) Patent Application Publication
(10) Pub. No.: US 2001/0041002 A1
(43) Pub. Date: Nov. 15, 2001

(54) SERVICE CREATION

(76) Inventor: JOHN H BAILEY, SUFFOLK (GB)

Correspondence Address: Nixon & Vanderhye P.C., 1100 North Glebe Road, 8th Floor, Arlington, VA, 22201, US

(21) Appl. No.: 09/043,361

(22) PCT Filed: Apr. 7, 1998
(86) PCT No.: PCT/GB98/01018

§ 371 Date: None

(30) Foreign Application Priority Data
Apr. 15, 1997 (GB) 97302581.0

(51) Int. Cl. G06K 9/00

(52) U.S. Cl. 382/165

(57) ABSTRACT

A service creation method and apparatus for use in preparing a graphical user interface for display to an end user, involve: scanning a coded representation of an image to be displayed for pre-determined formats e.g. colors and so identifying areas (18) of the image defined by the pre-determined formats; generating a list of the said areas; including in the said list information identifying actions to be performed, each action being associated with a respective one of said areas; and outputting a coded version of the image and the list. Areas having different properties may be identified on the basis of some characteristic—e.g. the size—of that area.

The present invention relates to a method and apparatus for service creation e.g. for an on-line service. Owing to the rapid development of electronic communications systems, such as the Internet, there is great interest in the presentation of on-line services. Whilst it is possible to generate the graphical user interface (GUI) for an on-line service in a dedicated manner, many service providers wish to be able to automate the generation of the service as much as possible.

According to one aspect of the present invention there is provided a method of service creation for use in preparing a graphical user interface for display to an end user, the method comprising:

scanning a coded representation of an image to be displayed for predetermined formats and so identifying areas of the image defined by the predetermined formats;

generating a list of the said areas;

including in the said list information identifying actions to be performed, each action being associated with a respective one of said areas; and

outputting a coded version of the image and the list.

Such method allows the rapid creation of applications for an on-line service, such as home shopping. A retailer who wishes to participate in an on-line shopping service simply presents a representation (e.g. a digital bit-map image) of the required graphical user interface to the system designed according to a service creator's design rules and the system automatically identifies the functional areas of the GUI (e.g. the buttons and hot spots) and converts the representation of the GUI into a functional GUI.

The pre-determined format that is scanned for is preferably a predetermined colour. Other suitable pre-determined formats may be symbols forming a border, border widths etc.

Preferably a feature type is allocated on the basis some characteristic of an identified area, such as its size.

The invention also provides a service creation apparatus for use in preparing a graphical user interface for display to an end user, the apparatus comprising:

means for scanning a coded representation of an image to be displayed for pre-determined formats and so identifying areas of the image defined by the pre-determined formats and generating a list of the said areas;

means enabling entry into the said list of information identifying actions to be performed, each action being associated with a respective one of said areas; and

an output to deliver a coded version of the image and the list.

The invention will now be described by way of example only with reference to the accompanying drawings in which:

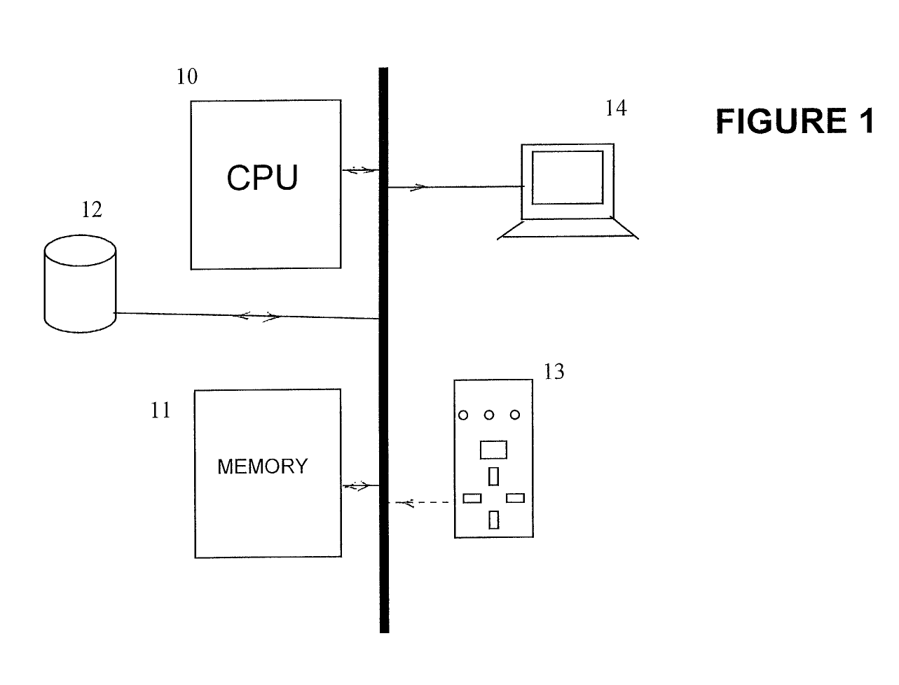

FIG. 1 is a block diagram of a system for delivering an interactive service;

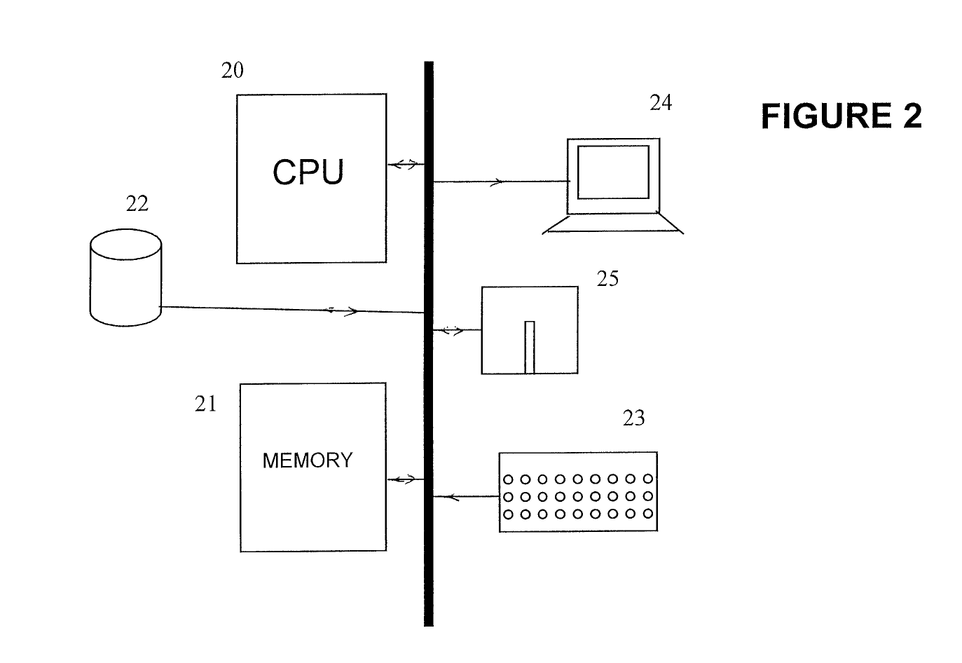

FIG. 2 shows a block diagram of a service creation tool in accordance with one embodiment of the invention;

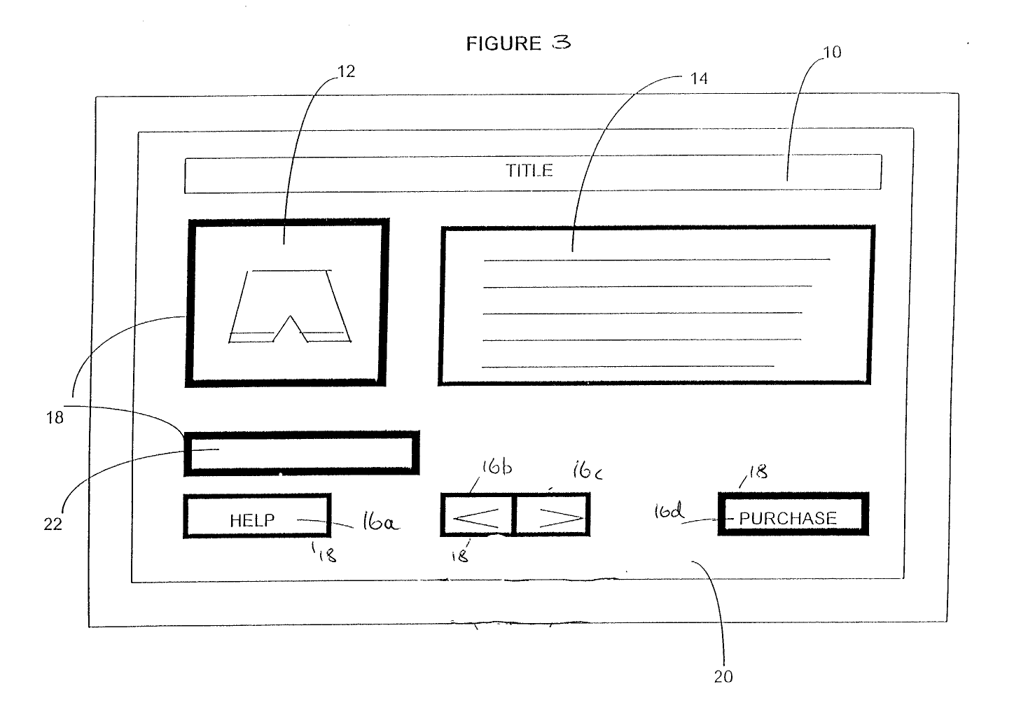

FIG. 3 shows an example of a representation of a graphical user interface to be created;

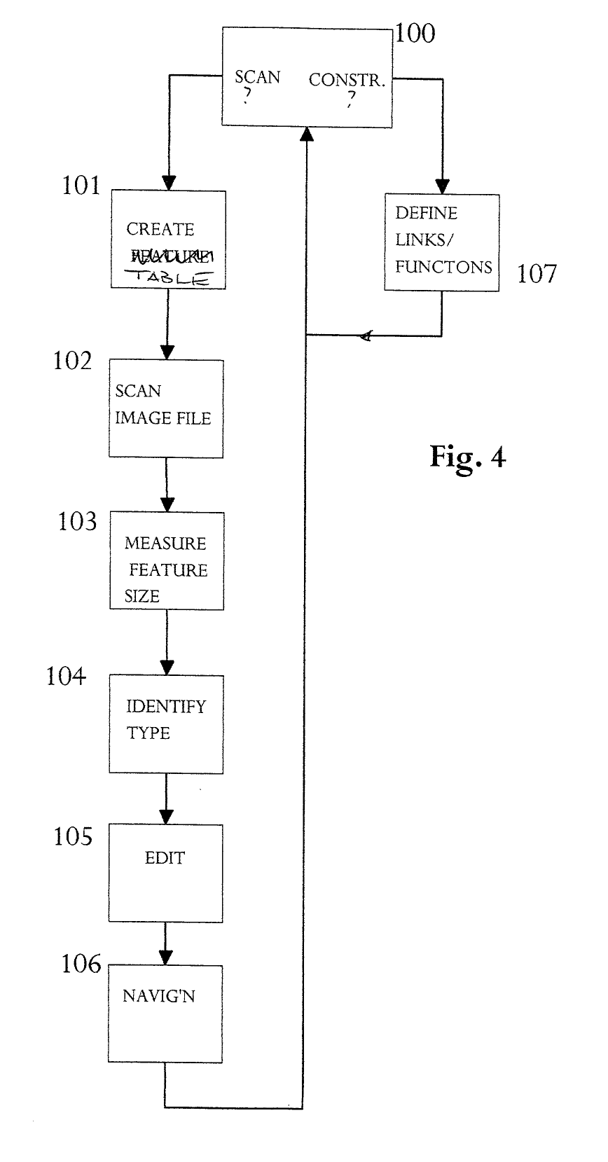

FIG. 4 is a flowchart showing the operation of the tool of FIG. 2;

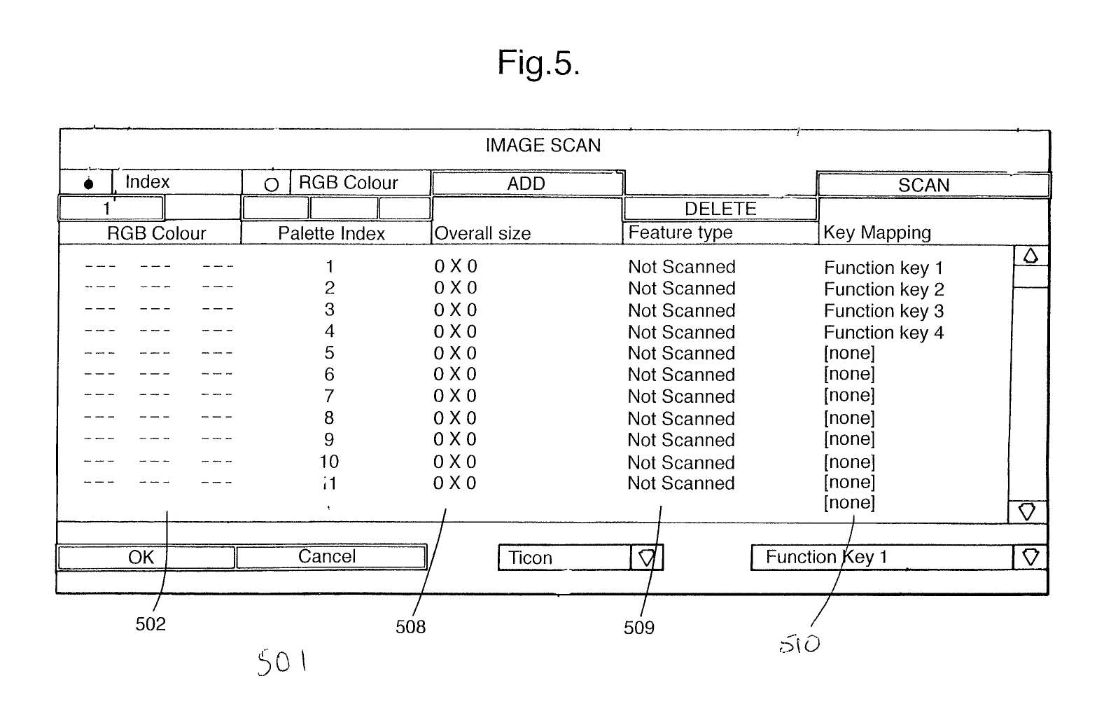

FIG. 5 shows an example of an initial image scan window presented to a service creator using the service creation tool according to the invention;

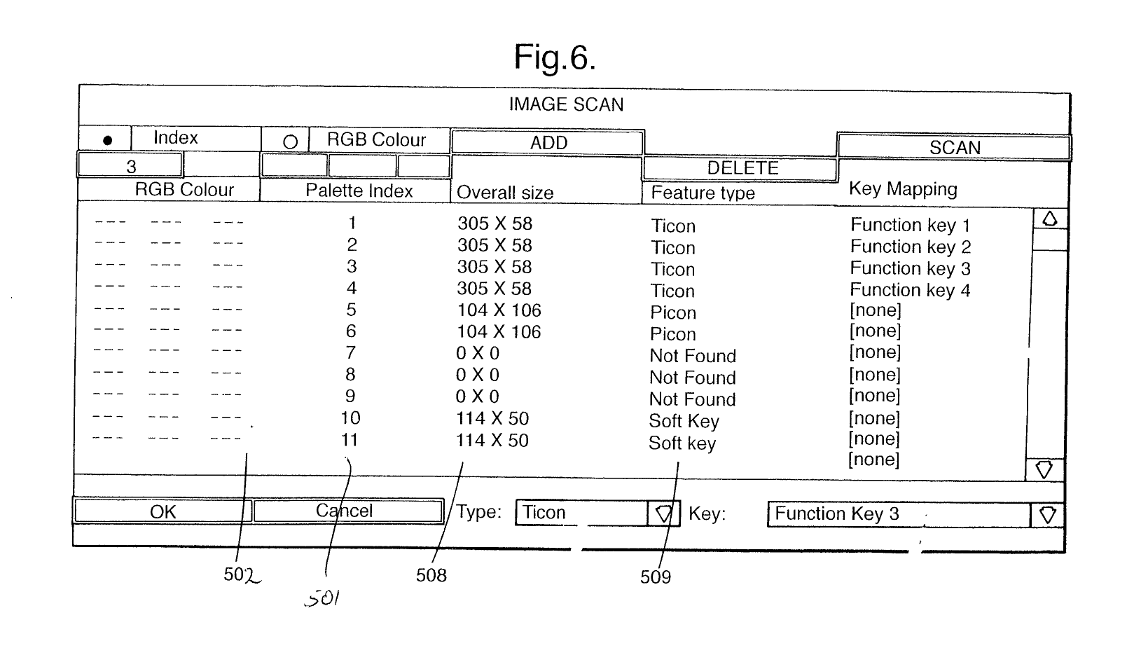

FIG. 6 shows an example of an image scan window after a representation of a GUI has been scanned by the service creation tool according to the invention; and

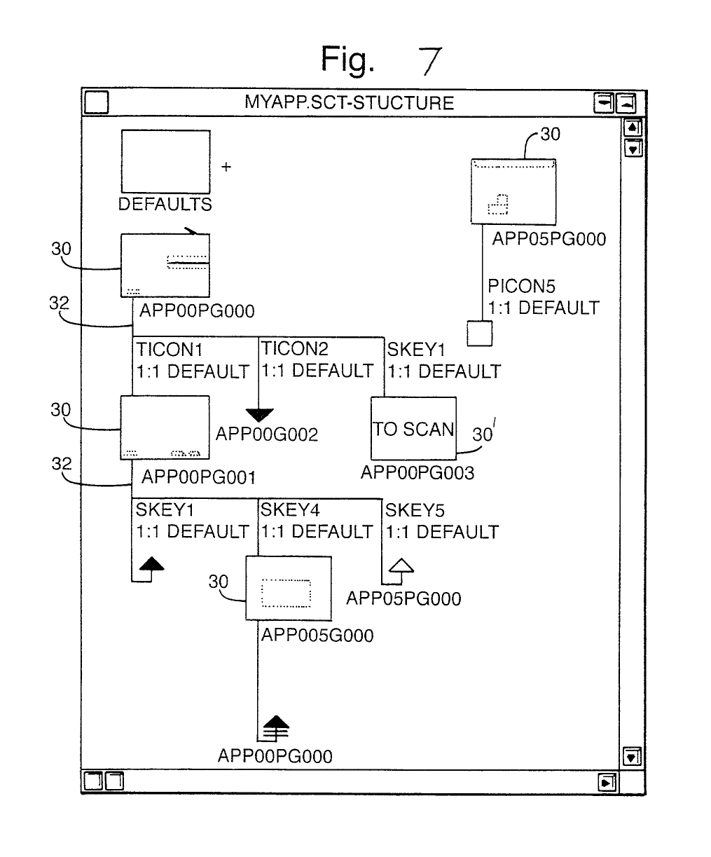

FIG. 7 shows an example of the structure of an application created by the service creation tool of the invention.

The context of the invention is the provision of a service to a user using a computer with a graphical user interface. The example described here is for to an airline interactive service. However it should be appreciated that this is exemplary only and the service creation tool is applicable to any such service. The service built is determined by the commissioner of the service e.g. the airline. The services to be provided may be provided by the airline itself or by selected suppliers e.g. car rental companies, hotel booking companies, duty-free retailers etc. It is envisaged that the user (the airline passenger) has, or is provided with, a computer 1 (FIG. 1) having a processor 10 connected to read-write memory 11, a disk store 12 (which may be remote from the computer 1 in a server common to a number of such computers), a keypad 13 and a visual display unit 14. In operation, by means of the processor under control of a control program loaded from the disk store into the memory, the user is initially presented with a screen image (referred to in this description as a page) offering a number of options, and is able to select among the options offered by operating keys on the keypad 13. The options offered by the first such page will probably consist entirely of opportunities to see a further such page offering additional options. In general a display screen will also offer options appropriate to the particular service, where control will be handed over to a further program or separate hardware for the provision of particular function such as the showing of a film or television programme on the visual display unit, the provision of telecommunications facilities, such as videotelephony, facsimile or internet access, interactive services such as ordering of goods (shopping services) and so forth. The precise nature of the facilities which the airline or other service provider makes accessible to the user by means of the graphical user interface is not of course material to the invention.

What is of significance is the operation of the control program to display the pages and respond to keystrokes made by the user. In this example it is envisaged that the mode of keypad control is as follows. The options referred to are represented in the screen image by distinct parts of the screen which bear some identification (referred to in this description as a “feature”) to inform the user of the nature of the option represented; a box containing a small picture or icon, a small picture in the shape of a key or button (“soft keys”), a box containing text such “Shopping”, “Fax” or the name of a film which can be shown, or simply a word with no box, for example. Each feature has a part (or the whole) which the control program can selectively cause to be highlighted—that is, cause to be displayed in a distinctive colour, it being understood that only one feature is highlighted at any given time. For example a feature consisting of a box may have a border which is highlighted in this way. Initially, one feature (the default or “first focus” feature) is highlighted; by the use of arrow keys ‘up’, ‘down’, ‘left’ and ‘right’, the user may highlight one of the other features—that is to say, the control program responds to the keystroke by restoring the original colour of the highlighted feature and apply the distinctive colour to another feature. When the user is satisfied that the feature corresponding to his desired choice is highlighted, he selects that feature by pressing a further (“select”) key, and the control program responds by initiation performance of the function assigned to that feature, be it display of a further such page, control of a video cassette player, execution of a communications program for fax transmission, or whatever has been predetermined by the system designer.

In order to perform these operations the control program needs to have access to data files, stored on the disk 12, which contain the following information, which together define the graphical user interface of the service being offered:

1. A digital image representation of each of the pages.

2. For each such image:

information enabling the control program to identify the highlightable parts of the features contained in the image.

information identifying the default feature.

inter-feature navigation information defining the response of the program to the arrow keys.

for each such feature, information defining the function to be performed when that feature is selected; i.e. the identifier of another such page to be displayed (this representing inter-screen navigation or “links” between pages), or the name of another program stored on the disk, which can provide some desired function (links to functions).

(User input by other means such as a mouse or touch-sensitive screen would be a possible alternative; in which case the inter-feature navigation information would no longer be necessary, nor the highlighting, but of course the feature areas would still need to be identified).

The construction of this data file is performed using the service creation tool which is now to be described. Normally this would be physically completely separate from the arrangements described above, and indeed it may well be that the operation of the tool would be entrusted by the service provider to another party, the service creator. The data file, once generated, can of course be transferred from the tool to the disk store 12 by any convenient means—e.g. on a floppy disk or via a telecommunications link.

The service creation tool 2 is shown in FIG. 2 and has a processor 20 connected to read-write memory 21, a hard disk 22, a keyboard 23, a visual display unit 24 and floppy disk drive 25. The operation of the processor is controlled by a control program stored on the hard disk 22 and loaded into the memory 21.

The process of generating the data files defining the graphical user interface may be viewed as consisting of a number of distinct stages:

1. definition of the appearance of the page image

2. identification of the features

3. definition of inter-feature navigation

4. definition of inter-image navigation and of functions to be performed.

For the most part, these steps will be described as occurring in the order given, though this is not always essential—for example the images do not all have to be defined at the outset, they could be introduced as required during the building up of a linked structure of pages during the definition of inter-page navigation.

The process is designed to accommodate the possibility that one may wish step 1—the design of the page—to be performed externally of the service creation tool, by someone other than the service creator—most likely by the service provider himself. Assuming this to be the case, then step 1 is performed using any readily available graphic design software (e.g. Adobe Photoshop, or Equilibrium DeBabelizer) to produce a digital file defining an image that the service provider wishes his users to see, this file being in a standard colour image format, typically a bitmap image or a compressed bitmap image such as the Microsoft Windows BMP format, the Zsoft Paintbrush PCX format, (or any others industru standard image file format). (In principle this stage could be performed by preparing a representation by hand and scanning it with an image scanner, though in such a case care would need to be taken to ensure that all colours that need to be distinguished are sufficiently different to be distinguished by the scanner used).

FIG. 3 shows an example of such a screen image. It includes the following features: a title bar 10, a pictorial icon (picon) 12, a text box 14 and four soft keys 16a, b, c and d. Each of the features which may be selected by a user includes a highlightable border 18. The colour of the borders will be discussed further below. Thus, in the example shown, it is intended that a user can receive further (related or unrelated) information by selecting the picon 12, the text 14 or any of the soft keys 16. The GUI may also have a graphical background 20 which may, for instance, portray the customer's logo or brand mark. An input box 22 is also shown.

In reality, of course, the various areas of the screen shown contain images and/or text laid out in an artistic manner, but these are not shown here.

The service provider (or other person designing the screen) also needs to indicate which parts of the design are the features. For this purpose certain picture elements (pixels are) flagged as indicating that they are part of a feature. Typically these pixels are those of the borders 18 and this will be assumed in the description which follows. The same principles can however be applied to a feature which has no border but consists of a symbol or a piece of text where it is the pixels of the icon or text letters themselves which are to be flagged. Additional bits could be included in the image file for this flagging, but, in order that a file of conventional format may be used, certain colours are reserved for identifying the features. Thus each feature is surrounded by a border of a respective pre-determined colour which cannot be used on any other part of the screen.

In this particular embodiment of the invention, we suppose that the file format is one (e.g. BMP) using a palette system. Such a system has typically 24-bit colour resolution (8 bits each for the red, blue and green components) but allows only 256 of the 2²⁴ possible colours to be used in any one image, so that the image can be represented by one 8-bit codeword (palette index) per pixel, plus a list (the “palette”) of the 256 24-bit colour values which the 256 indices represent. So an appropriate number n—perhaps fifteen—of the palette indices are reserved for identifying up to n selectable features. Conveniently this might be the indices 0 to n-1, though any could be chosen. The palette entries are then set to the R, G, B values of the colours that the service provider wishes to be used for displaying the respective borders when not highlighted. It may be that he wishes the n borders all to be the same colour (so that the colour change when highlighted is the more obvious): in principle more than one index can be set to the same colour, but in practice if one is using standard “off the shelf” software to create and to process standard format image files then this may not be possible: however the same effect can be achieved by using colours that are so alike that no difference can be perceived by the eye. For instance various shades of grey may be used. In RGB values this means that the value for R, G and B are substantially the same. Thus, say the first fifteen colours in the palette are to be allocated to highlights: these colours may be {128, 128, 128}; {128, 129, 128}; {129, 128, 128}; {128, 128, 129}; {127, 128, 128}; etc. These highlighted borders will appear to a user's eye to be identical but each of the highlight colours defines a single feature for scanning.

A service provider is provided with a set of design rules by the service creator. These design rules may specify parameters such as:

the width and height of the page, in pixels e.g. 640×480.

the width of the highlight borders, in pixels e.g. 4 pixels.

the position of the title, in pixels.

the minimum feature size.

how many soft keys are allowed per page and their size.

the maximum number of picons allowed per image.

the reserved palette indices.

For the service creation tool of the invention to be able to generate a GUI from an input image file, it is necessary for the file to follow the given design rules.

Once the image file is complete it is supplied to the service creator (e.g. on a floppy disk) who then copies it to the hard disk of the creation tool using the drive 25.

The operation of the service creation tool is illustrated by FIG. 4 which is a flowchart of the operation of its control program. In step 100 it receives a command from its keyboard (or via a mouse). Suppose that a source image file has already been stored, and that the operator enters a “scan” command to begin the feature identification phase discussed above, along with a filename to identify the source image file. Then in step 101 the processor 20 creates in memory a table, empty but for a list of the palette colours that are potentially used for a feature, and will shortly be scanned for, e.g. the first fifteen colours in the palette.

The colours that are automatically listed are configurable, although colours may be added to the list, and deleted from the list, at this stage.

Colours can be added to the list in two ways—either by palette index 501 or by RGB values 502. A colour can be represented by its RGB values, which will be three numbers each in a range 0 and 255 where the first number is the amount of red in the colour, the second, green; the third, blue. A palette index is a number between 0 and 255, that equates to a single RGB representation of the colour. For instance, palette index 1 may equate to RGB values ‘255,128,0’, which contains full red, green at half-strength, and no blue i.e. orange.

Preferably this table is also displayed on the display unit of the tool, as shown in FIG. 5, which serves to illustrate both the structure of the stored table and the form in which it might be displayed. In the next step 102 it examines the image file pixel by pixel to identify those pixels which use palette index 0: all other pixels are ignored. It then creates a temporary bitmap file, which can be a simple map with one bit per pixel which is set to 1 for those pixels which had index, and zero otherwise. This process is then repeated for all the other colours in the table.

Next (103) each temporary image is examined to ascertain the size of the area occupied by the pixels identified (or, rather, the size in pixels of the smallest rectangle which contains all the pixels flagged “1” in the temporary file). This is a simple algorithm to implement: if x and y are the horizontal and vertical position of a pixel, then if all the flagged pixels are examined and the maximum and minimum values of x and y (xₘₐₓ, xₘᵢₙ, yₘₐₓ and yₘᵢₙ) then the width is w=(xₘₐₓ−xₘᵢₙ) and the height is (yₘₐₓ−yₘᵢₙ). These values are added to the table and appear in the display which is then updated as seen in FIG. 6, where the entries in the overall size column 508 are in the form ‘horizontal size×vertical size’, for instance ‘304×58’. This entry is ‘0×0’ if no pixels are found of that colour. Note that this is the size of the feature including its highlight border.

The control program contains data identifying certain standard sizes which correspond to particular types of feature, and in step 104 compares each size w,h with these data and if it matches (within a preset error margin, e.g. 2%) then the associated feature type is recorded in the table (column 509) and in the display. The feature type 509 changes from ‘Not Scanned’ to one of ‘Not Found’, ‘Ticon’, ‘Picon’, ‘Softkey’, other feature type or ‘Unknown’:

If ‘Not Found’, then the service creation tool found no pixels in the image that are this colour, i.e. the overall size is ‘0×0’.

If ‘Ticon’, ‘Picon’, or ‘Softkey’ etc. then the image contains pixels of that colour, which the service creation tool has guessed to be a ticon, picon, or softkey. It makes this guess by comparing the overall size with the standard size defined in the design rules.

If ‘Unknown’, then the image does contain pixels of that colour, but the service creation tool cannot recognise the feature which those pixels represent. This may be because the pixels define a ticon, picon, or softkey that is not of, or near to the standard size and hence cannot be recognised; or because they are part of a graphic image and are not actually the highlightable border of a feature.

Once this automatic process is complete, then (105) the operator of the tool has the opportunity to edit the table, e.g. to add any missing information (replacing the “unknown” type entries, for example), and to add inter-feature navigation information, all of which are added to the table.

The right-hand column 510 is optionally provide for the possibility that the keypad 13 has “shortcut” keys which offer the user the facility of selecting certain options directly without having to use the arrow keys to navigate around the image. Thus with the entries shown, the actions corresponding to the first four features may be accessed directly by one of four such keys.

The navigation information could be shown in the displayed table, though it is not shown in FIG. 6 as it is preferred to display this on the display device by arrows superimposed on a display of the actual screen image itself.

Thus in step 106 the operator specifies for each feature, the reponse of the system to each of the four arrow keys, either no reponse(e.g. in the case of the left arrow key for a feature at the left hand-side of the screen) or of moving the highlight to another feature on the same page.

If desired, provision may also be made for editing the actual screen image files from within the tool itself, so that for example further features may be added, or the contents of boxes altered.

The purpose of identifying the different feature types should be explained.

Some typical types are listed below:

Picture Icons (Picons) 12.

Shopping Picons.

Text Icons (Ticons).

Soft keys 16.

Input boxes 22.

Highlightable Text Output Boxes.

Animations.

The types serve two purposes, in terms of the way they are treated by (a) the service creation tool and (b) the way they are treated in the final interactive service. (a) if the service creation tool permits editing of the image, then different constraints may be place on the editing process according to the type of feature: for example a text icon would not be permitted to have a picture inserted into it, and vice versa. (b) some features may perform a special function—for example an output box may be used to display messages.

Once the table is complete, it can be stored on disk, appropriately with a filename which is the same as that of the corresponding image file but with a different suffix or filename extension. If desired, a copy of an image file and its associated table may be made and edited separately, so that it forms a template for creating further such pages.

Control then returns to step 100, when the operator may choose to scan another image file, or enter a command to begin the construction of a service from the pages.

In the latter case, the definition of inter-screen navigation and of functions to be performed is carried out at step 107. The simplest was of achieving this is to add an additional column to the table (and similarly to the displayed version of the table) in which the necessary information can be entered using the keyboard. For those features which require the display of another screen image, one would type in the filename of the page, whilst for any other function one would type in the filename of the program (accompanied perhaps by command line options) that is to be executed to provide the desired function. Alternatively a more userfriendly input can be provide by displaying a screen (the “structure window”) such as that shown in FIG. 6, where each page that has been scanned (or otherwise created) is displayed as a box having an input line and a number of lines shown emanating from it (corresponding to the number of features that the image contains): each of these lines may then, by operator input (e.g. using a mouse) be connected to the input of another such box, or with a symbol representing a program to be run, so that the data representing these can be automatically generated and entered onto the relevant table.

The output files, for use by the service, are the various image files, and the corresponding tables. However, in practice we prefer to combine all the tables into a single file which lists the image file names, and the properties from the tables associated with them.

1. A method of service creation for use in preparing a graphical user interface for display to an end user, the method comprising:
scanning a coded representation of an image to be displayed for predetermined formats and so identifying areas of the image defined by the predetermined formats;
generating a list of the said areas;
including in the said list information identifying actions to be performed, each action being associated with a respective one of said areas; and
outputting a coded version of the image and the list.

2. A method according a claim 1 wherein each pre-determined format is the colour of elements of the image.

3. A method according to claim 2 wherein the coded image representation is a bit-map representation of the image containing a palette table of colour values corresponding to each of a plurality of colour indices and, for each picture element of the image, a corresponding index; and wherein each of said predetermined formats is a particular one of a subset of the colour indices.

4. A method according to any one of the preceding claims in which at least some of the actions identified in the list are the display of a further such image.

5. A method according to any one of the preceding claims including ascertaining a characteristic of each identified area, and allocating to at least some of the areas an associated feature type in dependence on that characteristic, and including, in the list, data identifying the feature type.

6. A method according to claim 5 wherein the characteristic is the the size of the identified area.

7. A service creation apparatus for use in preparing a graphical user interface for display to an end user, the apparatus comprising:
means for scanning a coded representation of an image to be displayed for pre-determined formats and so identifying areas of the image defined by the pre-determined formats and generating a list of the said areas;
means enabling entry into the said list of information identifying actions to be performed, each action being associated with a respective one of said areas; and
an output to deliver a coded version of the image and the list.

8. Apparatus according to claim 5 wherein each pre-determined format is the colour of elements of the image.

9. An apparatus according to claim 8 wherein the coded image representation is a bit-map representation of the image containing a palette table of colour values corresponding to each of a plurality of colour indices and, for each picture element of the image, a corresponding index; and wherein each of said predetermined formats is a particular one of a subset of the colour indices.

10. Apparatus according to claim 7, 8 or 9 including means operable to ascertain a characteristic of each identified area, to allocate to at least some of the areas an associated feature type in dependence on that characteristic, and to include, in the list, data identifying the feature type.

11. Apparatus according to claim 10 wherein the characteristic is the size of the identified area.

12. A method of service creation for use in preparing a graphical user interface for display to an end user substantially as described herein with reference to the accompanying drawings.

13. A service creation apparatus for use in preparing a graphical user interface for display to an end user substantially as described herein with reference to the accompanying drawings.
